(19) United States
(12) Patent Application Publication
(10) Pub. No.: US 2020/0014758 A1
(43) Pub. Date: Jan. 9, 2020

(54) ON-BOARD COMMUNICATION DEVICE, COMPUTER PROGRAM, AND MESSAGE DETERMINATION METHOD

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi, Osaka (JP)

(72) Inventors: Shogo Kamiguchi, Yokkaichi, Mie (JP); Shinichi Aiba, Yokkaichi, Mie (JP); Hiroshi Tateishi, Yokkaichi, Mie (JP); Tomohiro Mizutani, Yokkaichi, Mie (JP)

(21) Appl. No.: 16/494,539

(22) PCT Filed: Mar. 6, 2018
(86) PCT No.: PCT/JP2018/008457

§ 371 Date: Sep. 16, 2019

(30) Foreign Application Priority Data
Mar. 23, 2017 (JP) 2017-058056

(51) Int. Cl. H04L 29/08; B60R 16/023; B60W 40/107; H04L 29/06; B60W 50/16; B60W 50/04

(52) U.S. Cl. CPC H04L 67/12; B60R 16/023; B60W 40/107; H04L 2209/84; B60W 50/16; B60W 50/04; H04L 63/08

(57) ABSTRACT

An on-board communication device, a computer program, and a message determination method are provided. The on-board communication device determines the propriety of a periodic message based on a reception cycle. The on-board communication device determines the propriety of a received non-periodic message based on the contents of a periodic message determined as being proper. The on-board communication device stores correspondence of periodic messages to be used for determining the propriety of a non-periodic message to the non-periodic message and based on the stored correspondence, determines the propriety of a received non-periodic message based on whether or not the content of each periodic message, corresponding to the received non-periodic message, that has been received immediately before that received non-periodic message and that has been determined by the periodic message determination unit as being proper satisfies a predetermined condition.

### CROSS-REFERENCE TO RELATED APPLICATIONS

This application is the U.S. national stage of PCT/JP2018/008457 filed on Mar. 6, 2018, which claims priority of Japanese Patent Application No. JP 2017-058056 filed on Mar. 23, 2017, the contents of which are incorporated herein.

### TECHNICAL FIELD

The present disclosure relates to an on-board communication device that is installed in a vehicle and exchanges messages over an in-vehicle network, a computer program, and a message determination method.

### BACKGROUND

A large number of devices are mounted in a vehicle. The plurality of on-board devices are connected via a communication line, and operate in cooperation with one another by exchanging information with one another. In a conventional on-board communication system, a malicious device may be connected to the communication line, for example, and also, a legitimate on-board device may malfunction due to a computer virus or the like, for example. There is a concern that such a malicious device may cause a legitimate on-board device connected to the communication line to malfunction by performing unauthorized message transmission to the communication line, for example. Due to this, research is in progress of a technology for preventing malfunctioning, etc., of legitimate on-board devices caused by unauthorized messages transmitted by unauthorized devices.

In International Publication No. WO2015/170451, a method is proposed in which, in an on-board network system including a plurality of electronic control units that communicate via a bus in accordance with a Controller Area Network (CAN) protocol, data frames transmitted on the bus are received, and if a data frame that does not conform to a predetermined rule regarding transmission cycle is received, a specific identifier in the data frame is verified to detect an unauthorized act.

However, the unauthorized act detection method disclosed in International Publication No. WO2015/170451 uses a method of providing a specific identifier to data frames that are transmitted non-periodically, and there is a possibility of an unauthorized device illicitly acquiring the specific identifier. An unauthorized device having illicitly acquired the specific identifier can evade the unauthorized act detection method disclosed in International Publication No. WO2015/170451 by providing data frames from the device with the illicitly-acquired specific identifier and transmitting such data frames.

The present disclosure has been contrived in view of such circumstances, and aims to provide an on-board communication device, a computer program, and a message determination method for determining the propriety of messages that are transmitted non-periodically in an in-vehicle network.

### SUMMARY

An on-board communication device according to the present disclosure exchanges messages with another device mounted in a vehicle, the on-board communication device characterized for including: a periodic message determination unit that receives periodic messages that are transmitted periodically and determines propriety of the periodic messages; and a non-periodic message determination unit that receives non-periodic messages that are transmitted non-periodically and determines propriety of the received non-periodic messages based on the content of those periodic messages that have been determined as being proper by the periodic message determination unit.

Furthermore, the on-board communication device according to the present disclosure is characterized in that, if the non-periodic message determination unit receives a non-periodic message, the non-periodic message determination unit determines propriety of the received non-periodic message based on whether or not contents of a periodic message that has been received immediately before the non-periodic message and that has been determined by the periodic message determination unit as being proper satisfy a predetermined condition.

Furthermore, the on-board communication device according to the present disclosure is characterized for further including a correspondence storing unit that stores correspondence of periodic messages to be used for determining propriety of a non-periodic message to the non-periodic message, and in that the non-periodic message determination unit, based on the correspondence stored in the correspondence storing unit, determines whether or not the content of each periodic message, corresponding to the received non-periodic message, that has been received immediately before that received non-periodic message and that has been determined by the periodic message determination unit as being proper satisfies a predetermined condition.

Furthermore, the on-board communication device according to the present disclosure is characterized in that, if the periodic message determination unit receives a periodic message, the periodic message determination unit determines propriety of this received periodic message based on a period from the last time a periodic message was received until the reception of this received periodic message.

Furthermore, the on-board communication device according to the present disclosure is characterized in that the non-periodic message determination unit determines propriety of a non-periodic message providing notification of an acceleration operation of the vehicle based on a periodic message providing notification of whether or not a driver of the vehicle is present.

Furthermore, the on-board communication device according to the present disclosure is characterized in that the non-periodic message determination unit determines propriety of a non-periodic message providing notification of an acceleration operation of the vehicle based on a periodic message providing notification of a detection result of whether or not an obstacle is present in front of the vehicle.

Furthermore, the on-board communication device according to the present disclosure is characterized in that the non-periodic message determination unit determines propriety of a non-periodic message providing notification of an operation of opening a door of the vehicle based on a periodic message providing notification of a vehicle speed of the vehicle.

A computer program according to the present disclosure is characterized for causing a computer that exchanges messages with another device mounted in a vehicle to operate as: a periodic message determination unit that receives periodic messages that are transmitted periodically and determines propriety of the periodic messages; and a non-periodic message determination unit that receives non-periodic messages that are transmitted non-periodically and determines propriety of the received non-periodic messages based on the content of those periodic messages that have been determined as being proper by the periodic message determination unit.

A message determination method according to the present disclosure is characterized for: exchanging messages with (i.e. sending messages to and receiving messages from) another device mounted in a vehicle; receiving periodic messages that are transmitted periodically and determining propriety of the periodic messages; and receiving non-periodic messages that are transmitted non-periodically and determining propriety of the received non-periodic messages based on the content of those periodic messages that have been determined as being proper.

In the present disclosure, an on-board communication device exchanges messages with other devices via a communication line arranged inside a vehicle, for example. The messages transmitted by the other devices in the vehicle include periodic messages that are transmitted repeatedly at predetermined cycles and non-periodic messages that are transmitted in response to the occurrence of some events inside the vehicle. If the on-board communication device receives a periodic message, the on-board communication device determines the propriety of the periodic message based on a reception cycle, for example. Furthermore, if the on-board communication device receives a non-periodic message, the on-board communication device determines the propriety of the received non-periodic message based on the contents of a periodic message determined as being proper.

For example, if the on-board communication device receives a non-periodic message, the on-board communication device determines the propriety of the received non-periodic message based on whether or not the contents of a periodic message that has been received immediately before this non-periodic message and that has been determined as being proper satisfy a predetermined condition.

The propriety of a non-periodic message can be determined easily and accurately by performing the determination of the propriety of the non-periodic message based on not only the received non-periodic message but also the contents of a proper periodic message associated with the non-periodic message.

Furthermore, in the present disclosure, the on-board communication device stores correspondence of periodic messages to be used for determining the propriety of a non-periodic message to the non-periodic message. The on-board communication device, based on the stored correspondence, determines the propriety of a received non-periodic message based on whether or not the content of each periodic message, corresponding to the received non-periodic message, that has been received immediately before that received non-periodic message and that has been determined by the periodic message determination unit as being proper satisfies a predetermined condition. Accordingly, the on-board communication device can perform determination based on a periodic message associated with the non-periodic message, even if the on-board communication device receives various types of periodic messages.

Furthermore, in the present disclosure, the on-board communication device performs the determination of the propriety of a periodic message based on the period from the last time a periodic message was received until the current reception of the periodic message. Accordingly, the on-board communication device can perform determination of propriety based on whether or not the periodic messages have been transmitted at a correct cycle.

For example, the on-board communication device determines the propriety of a non-periodic message providing notification of an acceleration operation of the vehicle based on a periodic message providing notification of whether or not a driver of the vehicle is present. That is, if the on-board communication device receives a non-periodic message providing notification of an acceleration operation of the vehicle, the on-board communication device can determine that the non-periodic message is proper if a driver of the vehicle is present and can determine that the non-periodic message is improper if no driver is present.

For example, the on-board communication device determines the propriety of a non-periodic message providing notification of an acceleration operation of the vehicle based on a periodic message providing notification of a detection result of whether or not an obstacle is present in front of the vehicle. That is, if the on-board communication device receives a non-periodic message providing notification of an acceleration operation of the vehicle, the on-board communication device can determine that the non-periodic message is proper if no obstacle is present in front of the vehicle and can determine that the non-periodic message is improper if an obstacle is present.

For example, the on-board communication device determines propriety of a non-periodic message providing notification of an operation of opening a door of the vehicle based on a periodic message providing notification of a vehicle speed of the vehicle. That is, if the on-board communication device receives a non-periodic message providing notification of an operation of opening a door of the vehicle, the on-board communication device can determine that the non-periodic message is proper if the vehicle speed of the vehicle is lower than or equal to a predetermined speed and can determine that the non-periodic message is improper if the vehicle speed is higher than or equal to the predetermined speed.

### Advantageous Effects of Disclosure

According to the present disclosure, the propriety of messages that are transmitted non-periodically in an in-vehicle network can be determined easily and accurately by adopting a configuration in which the determination of the propriety of a non-periodic message is performed based on not only the received non-periodic message but also the contents of a proper periodic message associated with the non-periodic message.

### BRIEF DESCRIPTION OF DRAWINGS

FIG. 1 is a block diagram showing the configuration of an on-board communication system according to the present embodiment.

FIG. 2 is a schematic diagram showing one example of a determination condition table.

FIG. 3 is a schematic diagram showing one example of a determination of the propriety of non-periodic messages, performed by a non-periodic message determination unit.

FIG. 4 is a schematic diagram showing one example of the determination of the propriety of non-periodic messages, performed by the non-periodic message determination unit.

FIG. 5 is a flowchart showing a procedure of processing for determining the propriety of messages, performed by an on-board communication device.

FIG. 6 is a flowchart showing the procedure of the processing for determining the propriety of messages, performed by the on-board communication device.

### DETAILED DESCRIPTION OF PREFERRED EMBODIMENTS

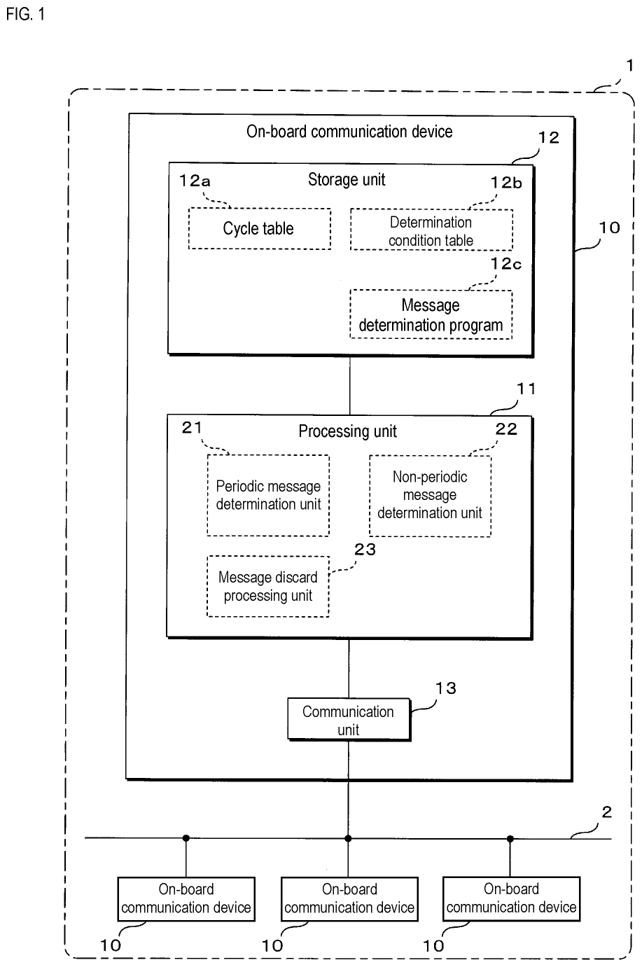

FIG. 1 is a block diagram showing the configuration of an on-board communication system according to the present embodiment. The on-board communication system according to the present embodiment has a configuration in which a plurality of on-board communication devices 10 mounted in a vehicle 1 are connected via a common communication line 2. Each on-board communication device 10 is a device such as an Electronic Control Unit (ECU), a car navigation device, or the like, for example, and exchanges information with other on-board communication devices 10 by exchanging messages via the communication line 2 and performs processing that the on-board communication device 10 is in charge of. Note that in the present embodiment, the on-board communication devices 10 perform communication in accordance with the CAN standard.

An on-board communication device 10 is configured to include a processing unit (processor) 11, a storage unit 12, a communication unit 13, etc. Note that, while the detailed configuration of only one on-board communication device 10 is shown in FIG. 1, the rest of the on-board communication devices 10 also have similar configurations. The processing unit 11 of the on-board communication device 10 is configured by using an arithmetic processing unit, such as a Central Processing Unit (CPU) or a Micro-Processing Unit (MPU), and performs various types of processing by executing programs stored in the storage unit 12, etc. In the present embodiment, the processing unit 11 performs processing for determining the propriety of messages received from other on-board communication devices 10 via the communication line 2 by executing a message determination program 12c stored in the storage unit 12, for example.

The storage unit 12 is configured by using a non-volatile memory element such as a flash memory or an Electrically Erasable Programmable Read Only Memory (EEPROM). The storage unit 12 stores programs to be executed by the processing unit 11, data necessary for processing, etc. In the present embodiment, the storage unit 12 stores a cycle table 12a and a determination condition table 12b that store information to be used for the processing for determining the propriety of received messages, and the message determination program 12c to be executed by the processing unit 11.

The communication unit 13 is connected to the communication line 2 and exchanges messages with other on-board communication devices 10 via the communication line 2. In the present embodiment, the communication unit 13 performs communication in accordance with the CAN standard. For example, the communication unit 13 may be an Integrated Circuit (IC) that can be referred to as a CAN controller, a CAN transceiver, or the like. The communication unit 13 transmits messages by converting messages for transmission that are provided as binary information from the processing unit 11 into binary electric signals and outputting the binary electric signals onto the communication line 2. The communication unit 13 receives messages by sampling the potential of the communication line 2 and provides the received messages to the processing unit 11.

Furthermore, by the processing unit 11 of the on-board communication device 10 according to the present embodiment executing the message determination program 12c stored in the storage unit 12, a periodic message determination unit 21, a non-periodic message determination unit 22, a message discard processing unit 23, etc., are realized as software-like functional blocks. Note that the message determination program 12c may be installed to the storage unit 12 by the message determination program 12c recorded on a recording medium such as an optical disc or a memory card being read by the on-board communication device 10, for example. Furthermore, the on-board communication device 10 may download the message determination program 12c from a server device or the like via a network such as a mobile telephone communication network or the internet and install the message determination program 12c to the storage unit 12, for example. Furthermore, the message determination program 12c may be installed to the storage unit 12 in ways other than these.

In the on-board communication system according to the present embodiment, each on-board communication device 10 can transmit periodic messages and/or non-periodic messages. Periodic messages are messages that are transmitted repeatedly at predetermined cycles. The on-board communication system according to the present embodiment includes an on-board communication device 10 that detects the vehicle speed of the vehicle 1 and transmits information of the detected vehicle speed in the form of periodic messages. Furthermore, the on-board communication system according to the present embodiment includes an on-board communication device 10 that determines whether or not a driver is present on the driver's seat of the vehicle 1 and transmits, as the determination result, information regarding whether or not a driver is present in the form of periodic messages. Furthermore, the on-board communication system according to the present embodiment includes an on-board communication device 10 that detects obstacles present in front of the vehicle 1 and transmits, as the detection result, information regarding whether or not an obstacle is present in the form of periodic messages. Note that these are mere examples of periodic messages, and the periodic messages transmitted and received in the vehicle 1 are not limited to these examples and any information may be transmitted in the form of periodic messages.

If a message is received by the communication unit 13, the periodic message determination unit 21 of the processing unit 11 first determines whether the received message is a periodic message or a non-periodic message. Communication in accordance with the CAN standard is performed in the on-board communication system according to the present embodiment, and the determination of whether a message is a periodic message or a non-periodic message can be performed based on the CAN ID included in the message. In the cycle table 12a in the storage unit 12, IDs of periodic messages that can be transmitted and received in the on-board communication system and transmission cycles of the periodic messages are stored in an associated state. The periodic message determination unit 21 can determine whether the received message is a periodic message or a non-periodic message by acquiring the ID from the received message and determining whether or not the acquired ID is an ID registered in the cycle table 12a.

Next, the periodic message determination unit 21 determines the propriety of the received periodic message. For example, the periodic message determination unit 21 starts the measurement of time by a timer the last time a periodic message was received, and measures the period (time) until the reception of the current periodic message. Note that this measurement of period is performed for each message ID. The periodic message determination unit 21 compares the measurement result of the period from the last reception until the current reception and the transmission cycle stored in the cycle table 12a, and determines that the received periodic message is proper if the measured period matches the transmission cycle in the cycle table 12a (or if the measured period is within a specific error range with respect to the transmission cycle). If the measured period does not match the transmission cycle in the cycle table 12a (or if the measured period exceeds the transmission cycle error range), the periodic message determination unit 21 determines that the received periodic message is improper.

For a periodic message determined by the periodic message determination unit 21 as being proper, the processing unit 11 stores the information (the contents) included in the periodic message for later. Here, the processing unit 11 stores at least the latest information for each periodic message for later, and may discard information that is not the latest information, information for which a certain period has elapsed from the reception of the information, or the like. Furthermore, for a periodic message determined by the periodic message determination unit 21 as being improper, the processing unit 11 does not store the information included in the periodic message.

In the on-board communication system according to the present embodiment, a non-periodic message, for example, is a message transmitted by an on-board communication device 10 having detected the occurrence of an event caused by an operation by a user of the vehicle 1 if such an event occurs, and can be referred to as an “event message,” for example. The on-board communication system according to the present embodiment includes an on-board communication device 10 that detects an operation (an acceleration operation) performed on the accelerator of the vehicle 1 and transmits a non-periodic message providing notification that an acceleration operation has been performed. Furthermore, the on-board communication system according to the present embodiment includes an on-board communication device 10 that detects an operation of opening a door of the vehicle 1 and transmits a non-periodic message providing notification that an operation of opening a door has been performed. Note that these are mere examples of non-periodic messages, and the non-periodic messages transmitted and received in the vehicle 1 are not limited to these examples and any information may be transmitted in the form of non-periodic messages.

The non-periodic message determination unit 22 of the processing unit 11 determines the propriety of a non-periodic message received by the communication unit 13. Note that, in the present embodiment, messages whose IDs are not registered in the cycle table 12a in the storage unit 12 are non-periodic messages. Determination conditions to be applied to non-periodic messages for the determination of propriety by the non-periodic message determination unit 22 are stored in the determination condition table 12b in the storage unit 12.

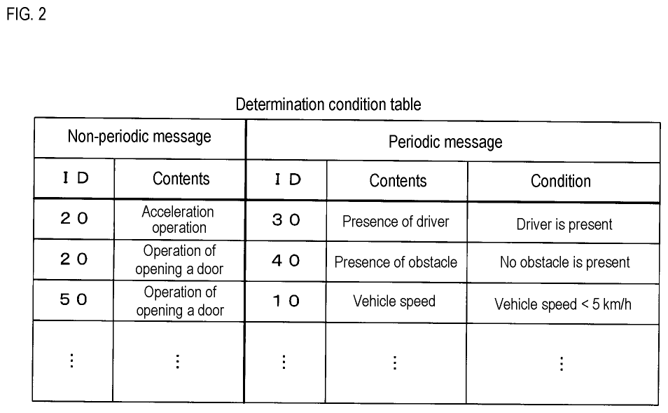

FIG. 2 is a schematic diagram showing one example of the determination condition table 12b. In the determination condition table 12b stored in the storage unit 12 of the on-board communication device 10 according to the present embodiment, for each non-periodic message, a periodic message to be used for the determination and a condition to be satisfied by the periodic message are stored in an associated state. In the determination condition table 12b that is shown, IDs of non-periodic messages, IDs of periodic messages, and conditions to be satisfied by the periodic messages are stored in an associated state. Note that, while the determination condition table 12b that is shown includes items indicating the contents of the non-periodic messages and the contents of the periodic messages, these items are included in order to make the description easy to understand and these items need not be included in the determination condition table 12b actually stored in the storage unit 12.

In the determination condition table 12b that is shown, the periodic message with the ID “30”, which provides notification of whether or not a driver is present, is associated with the non-periodic message with the ID “20”, which provides notification of an acceleration operation, and “Driver is present” is set as the condition of determination. Furthermore, the periodic message with the ID “40”, which provides notification of whether or not an obstacle is present, is associated with the non-periodic message with the ID “20”, which provides notification of an acceleration operation, and “No obstacle is present” is set as the condition of determination. In such a manner, a plurality of periodic messages may be associated with one non-periodic message as conditions of determination. Furthermore, the periodic message with the ID “10”, which provides notification of the vehicle speed of the vehicle 1, is associated with the non-periodic message with the ID “50”, which provides notification of an operation of opening a door, and “Vehicle speed <5 km/h” is set as the condition of determination. Note that these determination conditions are mere examples, and the determination of the propriety of non-periodic messages may be performed with various determination conditions other than these adopted.

If a non-periodic message is received by the communication unit 13, the non-periodic message determination unit 22 refers to the determination condition table 12b in the storage unit 12 and searches for a periodic message associated with the received non-periodic message. With regard to the periodic message associated with the non-periodic message, the non-periodic message determination unit 22 reads the information in the most lately received periodic message and determines whether or not the information that is read satisfies the condition set in the determination condition table 12b. If the information in the periodic message satisfies the condition in the determination condition table 12b, the non-periodic message determination unit 22 determines that the received non-periodic message is proper. If the information in the periodic message does not satisfy the condition in the determination condition table 12b, the non-periodic message determination unit 22 determines that the received non-periodic message is improper.

If a plurality of periodic messages are associated with one periodic message in the determination condition table 12b, the non-periodic message determination unit 22 determines that a received non-periodic message is proper if each one of the associated periodic messages satisfies the condition set in the determination condition table 12b. In contrast, if at least one of the associated periodic messages does not satisfy the condition, the non-periodic message determination unit 22 determines that the received non-periodic message is improper.

The message discard processing unit 23 of the processing unit 11 performs processing of discarding periodic messages determined by the periodic message determination unit 21 as being improper and non-periodic messages determined by the non-periodic message determination unit 22 as being improper. Messages may be discarded by performing processing of deleting information included in improper messages from the storage unit 12 of the on-board communication device 10, another memory, or the like, but it suffices to ensure at least that the information included in messages determined as being improper is not used in any subsequent processing in the on-board communication device 10.

Furthermore, information included in periodic messages determined by the periodic message determination unit 21 as being proper and non-periodic messages determined by the non-periodic message determination unit 22 as being proper is used for individual processing performed by each on-board communication device 10.

Note that the non-periodic message determination unit 22 performs the determination with respect to non-periodic messages based on periodic messages determined by the periodic message determination unit 21 as being proper. If a periodic message associated with a non-periodic message is determined by the periodic message determination unit 21 as being improper, the non-periodic message determination unit 22 does not (cannot) perform the determination of the propriety of the non-periodic message. In such a case, the non-periodic message received by the communication unit 13 may be treated as being proper without any determination being performed by the non-periodic message determination unit 22, or may be treated as being improper without any determination.

Furthermore, while a configuration is adopted in which the on-board communication device 10 discards messages determined as being improper in the present embodiment, the present disclosure is not limited to this, and a configuration may also be adopted in which processing other than discarding is performed. For example, the on-board communication device 10 may perform processing of notifying other on-board communication devices 10 in the vehicle 1, a server device outside the vehicle, the driver of the vehicle 1, etc., that an improper message was received. Furthermore, the on-board communication device 10 may perform processing of forcibly causing the on-board communication device 10 having transmitted an improper message to stop performing processing, processing of ceasing power supply to the on-board communication device 10, or the like, for example. Furthermore, a configuration may also be adopted in which the on-board communication device 10 performs the above-described processing if the number of times the determination that a received message is improper is made exceeds a predetermined number of times, rather than performing the above-described processing when the determination that a received message is improper is made once.

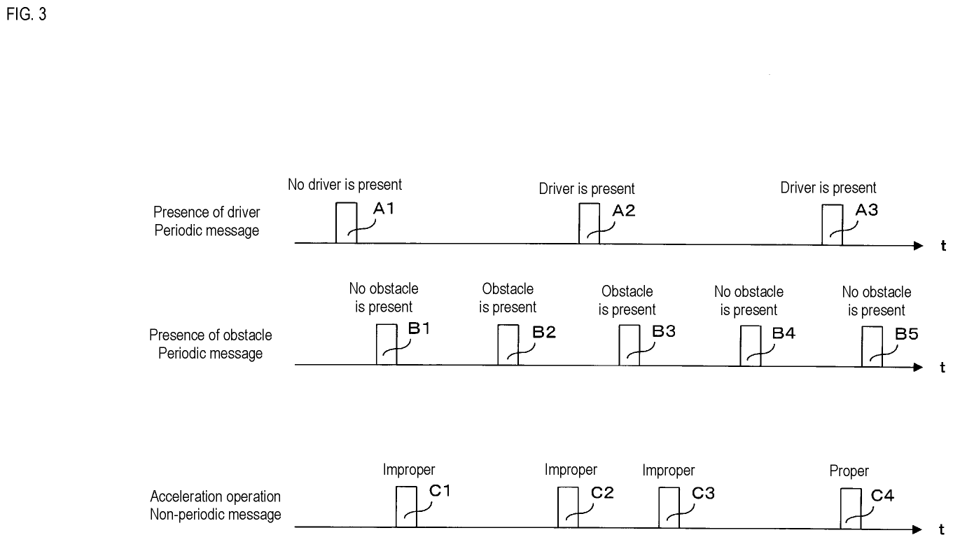

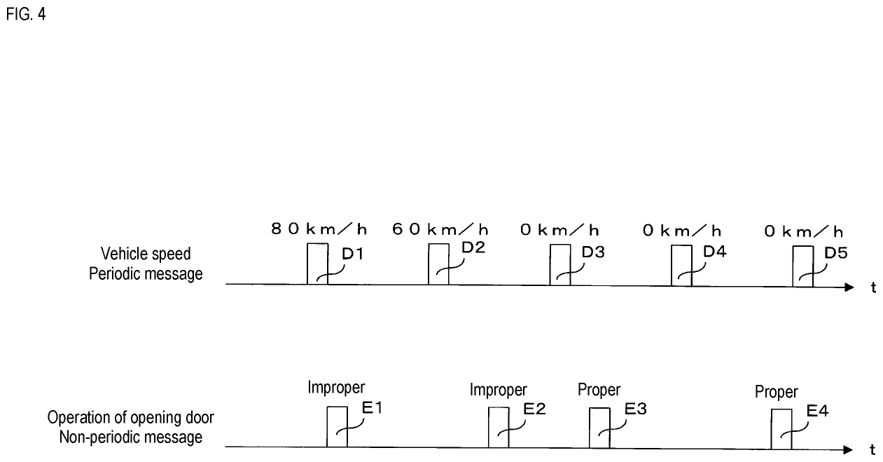

FIGS. 3 and 4 are schematic diagrams each showing one example of the determination of the propriety of non-periodic messages, performed by the non-periodic message determination unit 22. In FIGS. 3 and 4, reception timings of periodic messages and non-periodic messages received by a given on-board communication device 10 are shown with the horizontal axis indicating time t, and also, the contents of information included are shown for the periodic messages and the results of the determination of propriety are shown for the non-periodic messages. Note that, in the present example, it is assumed that all periodic messages were determined as being proper.

FIG. 3 shows, in order from the top, reception timings of periodic messages A1 to A3 providing notification of whether or not a driver is present, reception timings of periodic messages B1 to B5 providing notification of whether or not an obstacle is present, and reception timings of non-periodic messages C1 to C4 providing notification of an acceleration operation. The periodic messages A1 to A3 providing notification of whether or not a driver is present are transmitted at a predetermined cycle, and the on-board communication device 10 receives the three periodic messages A1 to A3 in the present example. In the present example, with regard to the contents of the information included in the periodic messages A1 to A3 providing notification of whether or not a driver is present, the periodic message A1 includes information indicating that no driver is present, the periodic message A2 includes information indicating that a driver is present, and the periodic message A3 includes information indicating that a driver is present, in the order of reception timing.

The periodic messages B1 to B5 providing notification of whether or not an obstacle is present are transmitted at a shorter cycle than the periodic messages A1 to A3 providing notification of whether or not a driver is present, and the on-board communication device 10 receives the five periodic messages B1 to B5 in the present example. The periodic messages B1 and B2 are received within a period from the reception of the periodic message A1 until the reception of the periodic message A2. The periodic messages B3 and B4 are received within a period from the reception of the periodic message A2 until the reception of the periodic message A3. The periodic message B5 is received after the reception of the periodic message A3. In the present example, with regard to the contents of the information included in the periodic messages B1 to B5 providing notification of whether or not an obstacle is present, the periodic message B1 includes information indicating that no obstacle is present, the periodic message B2 includes information indicating that an obstacle is present, the periodic message B3 includes information indicating that an obstacle is present, the periodic message B4 includes information indicating that no obstacle is present, and the periodic message B5 includes information indicating that no obstacle is present, in the order of reception timing.

The non-periodic messages C1 to C4 providing notification of an acceleration operation are transmitted non-periodically, and the on-board communication device 10 receives the four non-periodic messages C1 to C4 in the present example. Furthermore, a periodic message providing notification of whether or not a driver is present and a periodic message providing notification of whether or not an obstacle is present are associated, as determination conditions, with a non-periodic message providing notification of an acceleration operation, as shown in FIG. 2. The non-periodic message determination unit 22 of the on-board communication device 10, having received the non-periodic messages C1 to C4 providing notification of an acceleration operation, determines the propriety of the non-periodic messages C1 to C4 based on the contents of the most recently received ones of the periodic messages A1 to A3 providing notification of whether or not a driver is present and the periodic messages providing notification of whether or not an obstacle is present. The conditions for the non-periodic message determination unit 22 to determine that the non-periodic messages C1 to C4 providing notification of an acceleration operation are proper are that the contents of the periodic messages A1 to A3 providing notification of whether or not a driver is present indicate that a driver is present and that the contents of the periodic messages B1 to B5 providing notification of whether or not an obstacle is present indicate that no obstacle is present.

In the present example, the non-periodic message C1 providing notification of an acceleration operation is received by the on-board communication device 10 following the periodic message A1 providing notification of whether or not a driver is present and the periodic message B1 providing notification of whether or not an obstacle is present. The non-periodic message determination unit 22 acquires the contents of the periodic messages A1 and B1, which are associated with the received non-periodic message C1 and have been most recently received. The non-periodic message determination unit 22 determines that the received non-periodic message C1 is improper, because the contents of the periodic message B1 indicate that no obstacle is present and satisfy the condition set in the determination condition table 12b but the contents of the periodic message A1 indicate that no driver is present and do not satisfy the condition.

The non-periodic message C2 providing notification of an acceleration operation is received after the reception of the periodic message B2 providing notification of whether or not an obstacle is present. The non-periodic message determination unit 22 acquires the contents of the periodic messages A1 and B2, which have been most recently received in relation to the received non-periodic message C2. The non-periodic message determination unit 22 determines that the received non-periodic message C2 is improper, because the contents of the periodic message A1 indicate that no driver is present and do not satisfy the condition and the contents of the periodic message B2 indicate that an obstacle is present and do not satisfy the condition.

The non-periodic message C3 providing notification of an acceleration operation is received following the periodic message A2 providing notification of whether or not a driver is present and the periodic message B3 providing notification of whether or not an obstacle is present. The non-periodic message determination unit 22 acquires the contents of the periodic messages A2 and B3, which have been most recently received in relation to the received non-periodic message C3. The non-periodic message determination unit 22 determines that the received non-periodic message C3 is improper, because while the contents of the periodic message A2 indicate that a driver is present and satisfy the condition, the contents of the periodic message B3 indicate that an obstacle is present and do not satisfy the condition.

The non-periodic message C4 providing notification of an acceleration operation is received following the periodic message B4 providing notification of whether or not an obstacle is present and the periodic message A3 providing notification of whether or not a driver is present. The non-periodic message determination unit 22 acquires the contents of the periodic messages B4 and A3, which have been most recently received in relation to the received non-periodic message C4. The non-periodic message determination unit 22 determines that the received non-periodic message C4 is proper, because the contents of the periodic message B4 indicate that no obstacle is present and satisfy the condition and the contents of the periodic message A3 indicate that a driver is present and satisfy the condition.

FIG. 4 shows, in order from the top, reception timings of periodic messages D1 to D5 providing notification of the vehicle speed of the vehicle 1 and reception timings of non-periodic messages E1 to E5 providing notification of an operation of opening a door. The periodic messages D1 to D5 providing notification of the vehicle speed are transmitted at a predetermined cycle, and the on-board communication device 10 receives the five periodic messages D1 to D5 in the present example. In the present example, with regard to the contents of the information included in the periodic messages D1 to D5 providing notification of the vehicle speed, the periodic message D1 includes information indicating 80 km/h, the periodic message D2 includes information indicating 60 km/h, the periodic message D3 includes information indicating 0 km/h, the periodic message D4 includes information indicating 0 km/h, and the periodic message D5 includes information indicating 0 km/h, in the order of reception timing.

The non-periodic messages E1 to E4 providing notification of an operation of opening a door are transmitted non-periodically, and the on-board communication device 10 receives the four non-periodic messages E1 to E4 in the present example. Furthermore, a periodic message providing notification of vehicle speed is associated, as a determination condition, with a non-periodic message providing notification of an operation of opening a door, as shown in FIG. 2. The non-periodic message determination unit 22 of the on-board communication device 10, having received the non-periodic messages E1 to E4 providing notification of an operation of opening a door, determines the propriety of the non-periodic messages E1 to E4 based on the contents of the most recently received ones of the periodic messages D1 to D5 providing notification of the vehicle speed. The condition for the non-periodic message determination unit 22 to determine that the non-periodic messages E1 to E4 providing notification of an operation of opening a door are proper is that the vehicle speed included in the periodic messages D1 to D5 providing notification of the vehicle speed is lower than 5 km/h.

In the present example, the non-periodic message E1 providing notification of an operation of opening a door is received by the on-board communication device 10 following the periodic message D1 providing notification of the vehicle speed. The non-periodic message determination unit 22 acquires the contents of the periodic message D1, which is associated with the received non-periodic message E1 and has been most recently received. The non-periodic message determination unit 22 determines that the received non-periodic message E1 is improper because the contents of the periodic message D1 indicate 80 km/h and do not satisfy the condition set in the determination condition table 12b.

The non-periodic message E2 providing notification of an operation of opening a door is received by the on-board communication device 10 following the periodic message D2 providing notification of the vehicle speed. The non-periodic message determination unit 22 acquires the contents of the periodic message D2, which has been most recently received in relation to the received non-periodic message E2. The non-periodic message determination unit 22 determines that the received non-periodic message E2 is improper because the contents of the periodic message D2 indicate 60 km/h and do not satisfy the condition set in the determination condition table 12b.

The non-periodic message E3 providing notification of an operation of opening a door is received by the on-board communication device 10 following the periodic message D3 providing notification of the vehicle speed. The non-periodic message determination unit 22 acquires the contents of the periodic message D3, which has been most recently received in relation to the received non-periodic message E3. The non-periodic message determination unit 22 determines that the received non-periodic message E3 is proper because the contents of the periodic message D3 indicate 0 km/h and satisfy the condition set in the determination condition table 12b.

The non-periodic message E4 providing notification of an operation of opening a door is received by the on-board communication device 10 following the periodic message D4 providing notification of the vehicle speed. The non-periodic message determination unit 22 acquires the contents of the periodic message D4, which has been most recently received in relation to the received non-periodic message E4. The non-periodic message determination unit 22 determines that the received non-periodic message E4 is proper because the contents of the periodic message D4 indicate 0 km/h and satisfy the condition set in the determination condition table 12b.

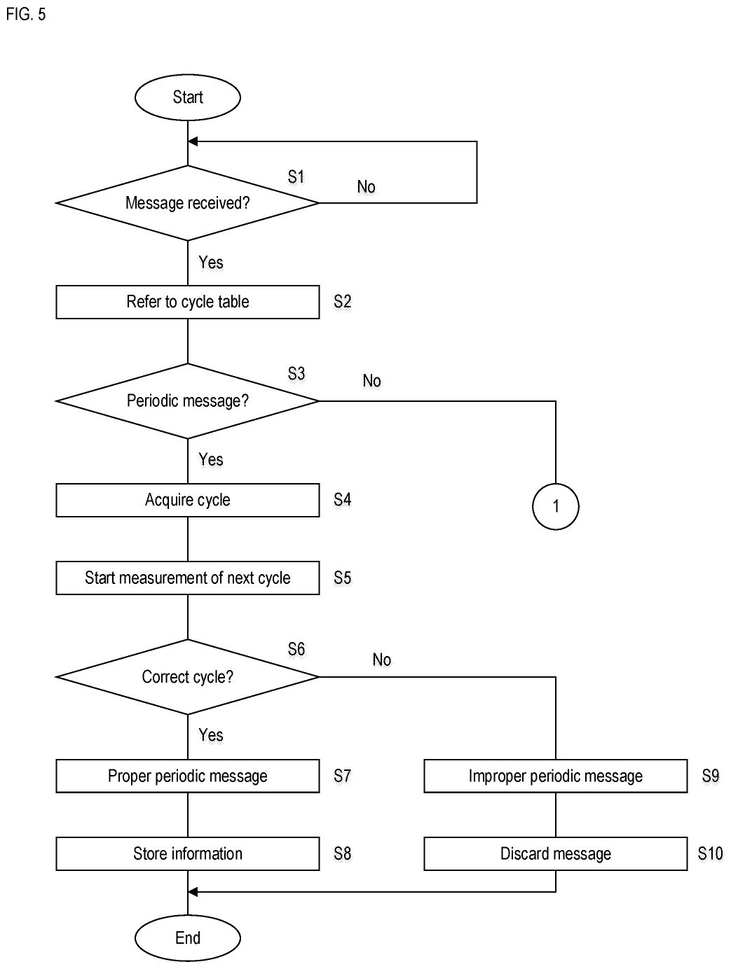

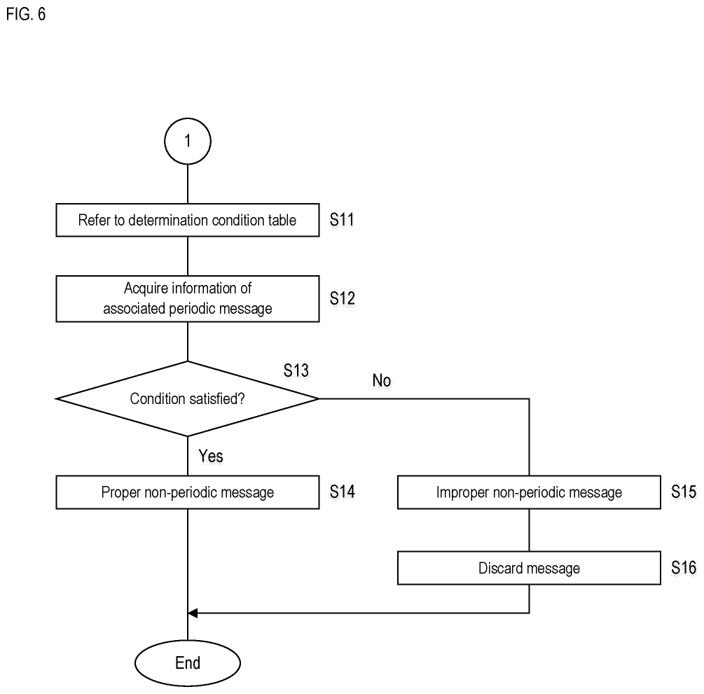

FIGS. 5 and 6 are flowcharts showing a procedure of the processing for determining the propriety of messages, performed by the on-board communication device 10. The processing unit 11 of the on-board communication device 10 determines whether or not a message from another on-board communication device 10 is received by the communication unit 13 (step S1). If no message is received (S1: NO), the processing unit 11 waits until a message is received. If a message is received (S1: YES), the periodic message determination unit 21 of the processing unit 11 refers to the cycle table 12a stored in the storage unit 12 (step S2). The periodic message determination unit 21 determines whether or not the received message is a periodic message by determining whether or not the ID of the received message is registered in the cycle table 12a (step S3).

If the received message is a periodic message (S3: YES), the periodic message determination unit 21, with regard to messages with the same ID as the received periodic message, acquires the time from the last time a periodic message was received until the reception of the current periodic message, i.e., acquires the reception cycle of this periodic message (step S4). The processing unit 11 is performing the measurement of a cycle for each message ID by using a timer function or the like, and the periodic message determination unit 21 can acquire the cycle of the received periodic message by acquiring this measurement result. After acquiring the cycle, the periodic message determination unit 21 starts the measurement of the next cycle (step S5).

The periodic message determination unit 21, having acquired the cycle of the received periodic message, determines whether or not the acquired cycle is the correct cycle by comparing the acquired cycle with the cycle registered in the cycle table 12a (step S6). If the acquired cycle is the correct cycle (S6: YES), the periodic message determination unit 21 determines that the received periodic message is a proper periodic message (step S7). The periodic message determination unit 21 stores the information included in the periodic message determined as being proper to the storage unit 12, etc. (step S8), and ends processing.

If the acquired cycle is not the correct cycle (S6: NO), the periodic message determination unit 21 determines that the received periodic message is an improper periodic message (step S9). The message discard processing unit 23 of the processing unit 11 performs processing of discarding the periodic message determined by the periodic message determination unit 21 as being improper (step S10), and ends processing.

If the received message is not a periodic message (S3: NO), or that is, if the received message is a non-periodic message, the non-periodic message determination unit 22 of the processing unit 11 refers to the determination condition table 12b stored in the storage unit 12 (step S11), and acquires the determination condition, periodic message ID, and the like associated with the received non-periodic message. Following this, the non-periodic message determination unit 22 acquires, from among information relating to periodic messages that is stored in step S8, information in the periodic message associated with the received non-periodic message (step S12). The non-periodic message determination unit 22 determines whether or not the acquired information satisfies the condition set in the determination condition table 12b (step S13).

If the acquired information satisfies the determination condition (S13: YES), the non-periodic message determination unit 22 determines that the received non-periodic message is a proper non-periodic message (step S14), and ends processing. If the acquired information does not satisfy the determination condition (S13: NO), the non-periodic message determination unit 22 determines that the received non-periodic message is an improper non-periodic message (step S15). The message discard processing unit 23 of the processing unit 11 performs processing of discarding the non-periodic message determined by the non-periodic message determination unit 22 as being improper (step S16), and ends processing.

An on-board communication device 10 according to the present embodiment, with the configuration described up to this point, exchanges messages with other on-board communication devices 10 via the communication line 2 arranged inside the vehicle 1. The messages transmitted by the on-board communication device 10 include periodic messages that are transmitted repeatedly at predetermined cycles and non-periodic messages that are transmitted in response to the occurrence of some events inside the vehicle. If the on-board communication device 10 receives a periodic message, the on-board communication device 10 determines the propriety of the periodic message based on a reception cycle. Furthermore, if the on-board communication device 10 receives a non-periodic message, the on-board communication device 10 determines the propriety of the received non-periodic message based on the contents of a periodic message determined as being proper. That is, if the on-board communication device 10 receives a non-periodic message, the on-board communication device 10 determines the propriety of the received non-periodic message based on whether or not the contents of a periodic message that has been received immediately before this non-periodic message and that has been determined as being proper satisfy a predetermined condition. The on-board communication device 10 can determine the propriety of a non-periodic message easily and accurately by performing the determination of the propriety of the non-periodic message based on not only the received non-periodic message but also the contents of a proper periodic message associated with the non-periodic message.

Furthermore, the on-board communication device 10 stores correspondence of periodic messages to be used for determining the propriety of a non-periodic message to the non-periodic message in the form of the determination condition table 12b in the storage unit 12. The on-board communication device 10, based on the correspondence stored in the determination condition table 12b, determines the propriety of a received non-periodic message based on whether or not the content of each periodic message, corresponding to the received non-periodic message, that has been received immediately before that received non-periodic message and that has been determined by the periodic message determination unit as being proper satisfies a predetermined condition. Accordingly, the on-board communication device 10 can perform determination based on a periodic message associated with the non-periodic message, even if the on-board communication device 10 receives various types of periodic messages.

Furthermore, the on-board communication device 10 performs the determination of the propriety of a periodic message based on the period from the last time a periodic message was received until the current reception of the periodic message. Accordingly, the on-board communication device 10 can perform determination of propriety based on whether or not the periodic messages have been transmitted at a correct cycle.

Furthermore, the on-board communication device 10 determines the propriety of a non-periodic message providing notification of an acceleration operation of the vehicle 1 based on a periodic message providing notification of whether or not a driver of the vehicle 1 is present. That is, if the on-board communication device 10 receives a non-periodic message providing notification of an acceleration operation of the vehicle 1, the on-board communication device 10 determines that the non-periodic message is proper if a driver of the vehicle 1 is present and determines that the non-periodic message is improper if no driver is present.

Furthermore, the on-board communication device 10 determines the propriety of a non-periodic message providing notification of an acceleration operation of the vehicle 1 based on a periodic message providing notification of a detection result of whether or not an obstacle is present in front of the vehicle 1. That is, if the on-board communication device 10 receives a non-periodic message providing notification of an acceleration operation of the vehicle 1, the on-board communication device 10 determines that the non-periodic message is proper if no obstacle is present in front of the vehicle 1 and determines that the non-periodic message is improper if an obstacle is present.

Furthermore, the on-board communication device 10 determines propriety of a non-periodic message providing notification of an operation of opening a door of the vehicle 1 based on a periodic message providing notification of a vehicle speed of the vehicle 1. That is, if the on-board communication device 10 receives a non-periodic message providing notification of an operation of opening a door of the vehicle 1, the on-board communication device 10 determines that the non-periodic message is proper if the vehicle speed of the vehicle 1 is lower than or equal to a predetermined speed and determines that the non-periodic message is improper if the vehicle speed is higher than or equal to the predetermined speed.

Note that, while a method in which the propriety of a periodic message is determined based on the period from the last time the periodic message was received until the current reception of the periodic message, i.e., the reception cycle of the periodic message, has been described in the present embodiment as the method in which the determination with respect to periodic messages is performed by the on-board communication device 10, the method for determining the propriety of periodic messages is not limited to this. For example, a configuration may also be adopted in which a periodic message is transmitted with a message authenticator generated through encryption processing provided to the periodic message, and the on-board communication device 10 receiving this determines the propriety of the periodic message by determining the propriety of the message authenticator provided to the periodic message.

Furthermore, the on-board communication device 10 may be a gateway device or the like to which a plurality of communication lines are connected and which relays messages between the communication lines. In this case, a configuration may also be adopted in which the gateway device performs the determination of the propriety of periodic messages and the determination of the propriety of non-periodic messages for each communication line and does not relay messages determined as being improper.

Furthermore, while the on-board communication system according to the present embodiment has a configuration in which each on-board communication device 10 mounted in the vehicle 1 performs the determination of the propriety of periodic messages and non-periodic messages, the present disclosure is not limited to this. For example, a configuration may be adopted in which one on-board communication device 10 included in the on-board communication system performs the determination of the propriety of messages, and the on-board communication device 10, if determining that a message is improper, provides notification to that effect to the other devices. If such a configuration is adopted, a gateway device or the like is suitable as the device performing the determination of the propriety of messages on behalf of the other devices.

Furthermore, while the on-board communication device 10 has a configuration in which the processing unit 11 performs the determination of the propriety of periodic messages, the determination of the propriety of non-periodic messages, the processing of discarding improper messages, etc., the present disclosure is not limited to this. For example, a configuration may be adopted in which the communication unit 13 performs some of or all of the determination of the propriety of periodic messages, the determination of the propriety of non-periodic messages, and the processing of discarding improper messages.

1. An on-board communication device configured to exchange messages with another device mounted in a vehicle, the on-board communication device comprising:
a periodic message determination unit that is configured receive periodic messages that are transmitted periodically and to determine propriety of the periodic messages; and
a non-periodic message determination unit that is configured to receive non-periodic messages that are transmitted non-periodically and to determine propriety of the received non-periodic messages based on the contents of those periodic messages that have been determined as being proper by the periodic message determination unit.

2. The on-board communication device according to claim 1, wherein if the non-periodic message determination unit receives a non-periodic message, the non-periodic message determination unit determines propriety of the received non-periodic message based on whether or not the content of a periodic message that has been received immediately before the non-periodic message and that has been determined by the periodic message determination unit as being proper satisfies a predetermined condition.

3. The on-board communication device according to claim 2, further comprising a correspondence storing unit that stores correspondence of periodic messages to be used for determining propriety of a non-periodic message to the non-periodic message, wherein
the non-periodic message determination unit, based on the correspondence stored in the correspondence storing unit, determines whether or not the content of each periodic message, corresponding to the received non-periodic message, that has been received immediately before that received non-periodic message and that has been determined by the periodic message determination unit as being proper satisfies a predetermined condition.

4. The on-board communication device according to claim 1, wherein, if the periodic message determination unit receives a periodic message, the periodic message determination unit determines propriety of this received periodic message based on a period from the last time a periodic message was received until the reception of this received periodic message.

5. The on-board communication device according to claim 1, wherein the non-periodic message determination unit determines propriety of a non-periodic message providing notification of an acceleration operation of the vehicle based on a periodic message providing notification of whether or not a driver of the vehicle is present.

6. The on-board communication device according to claim 1, wherein the non-periodic message determination unit determines propriety of a non-periodic message providing notification of an acceleration operation of the vehicle based on a periodic message providing notification of a detection result of whether or not an obstacle is present in front of the vehicle.

7. The on-board communication device according to claim 1, wherein the non-periodic message determination unit determines propriety of a non-periodic message providing notification of an operation of opening a door of the vehicle based on a periodic message providing notification of a vehicle speed of the vehicle.

8. A computer program causing a computer that exchanges messages with another device mounted in a vehicle to operate as:
a periodic message determination unit that receives periodic messages that are transmitted periodically and determines propriety of the periodic messages; and
a non-periodic message determination unit that receives non-periodic messages that are transmitted non-periodically and determines propriety of the received non-periodic messages based on the content of those periodic messages that have been determined as being proper by the periodic message determination unit.

9. A message determination method comprising:
exchanging messages with another device mounted in a vehicle;
receiving periodic messages that are transmitted periodically and determining propriety of the periodic messages; and
receiving non-periodic messages that are transmitted non-periodically and determining propriety of the received non-periodic messages based on the content of those periodic messages that have been determined as being proper.
